(19) United States
(12) Patent Application Publication
(10) Pub. No.: US 2021/0307429 A1
(43) Pub. Date: Oct. 7, 2021

(54) GRAPHENE FOAM-BASED ANTIVIRAL FILTRATION ELEMENT AND FILTRATION DEVICES CONTAINING SAME

(71) Applicant: Nanotek Instruments Group, LLC, Dayton, OH (US)

(72) Inventors: Aruna Zhamu, Springboro, OH (US); Bor Z. Jang, Centerville, OH (US)

(21) Appl. No.: 16/839,847

(22) Filed: Apr. 3, 2020

(51) Int. Cl. A41D 13/11; B32B 9/00; B32B 9/04; B32B 5/18; B32B 5/24; B32B 7/12

(52) U.S. Cl. CPC A41D 13/1192; A41D 13/1161; B32B 9/007; B32B 9/047; B32B 5/18; B32B 2535/00; B32B 7/12; B32B 2250/03; B32B 2307/72; B32B 2307/7145; B32B 5/245

(57) ABSTRACT

Provided is an face mask comprising: (a) a mask body configured to cover at least wearer's mouth and nose; and (b) a fastener to hold the mask in place on the wearer; wherein the mask body includes (i) an air-permeable outer layer preferably comprising a hydrophobic material (e.g. water-repelling fibers), (ii) an inner layer located on a wearer's side when the mask is worn, and (iii) a graphene foam layer disposed in the mask body between the outer layer and the inner layer or embedded (totally or partially) in the outer layer or the inner layer. The foam pore wall graphene surfaces may be deposited with an antiviral or anti-bacteria compound.

The present disclosure relates generally to the field of filters and, particularly, to an antiviral filtration element, filtering devices containing this element, and a method of operating same. This disclosure is related to a filtration device that is capable of filtrating out bacteria, viruses, other air-borne particles, or liquid-borne contaminants. This device may be an oral and/or nasal air filter that can remove and neutralize harmful virus from inhaled air contaminated with such virus, and from contaminated air exhaled from patients infected with such virus. In particular, the disclosure relates to such a device in the form of a face mask. The disclosure also relates to filter materials or members suitable for use in such a face mask and other filtration devices

### BACKGROUND

The inhalation of air contaminated by harmful virus and/or other micro-organisms is a common route for infection of human beings, particularly health workers and others caused to work with infected humans or animals. It is also known that air exhaled by infected patients is a source of contamination. At the present time the risk of infection by the so called “COVID-19” coronavirus is of particular concern. Masks incorporating a suitable filter material would be ideal for use as a barrier to prevent infection by this virus.

Air filters that are believed to be capable of removing such virus and/or other micro-organisms are known in the art. One type of such a filter comprises a fibrous or particulate substrate or layer and an antiviral or anti-bacteria compound deposited upon the surface and/or into the bulk of such a substrate or layer. This compound captures and/or neutralizes virus and/or other micro-organisms of concern. Examples of disclosures of such filters are summarized below:

For instance, U.S. Pat. No. 4,856,509 provides a face mask wherein select portions of the mask contain a viral destroying agent such as citric acid. U.S. Pat. No. 5,767,167 discloses aerogel foams suited for filtering media for capture of micro-organisms such as virus. U.S. Pat. No. 5,783,502 provides a fabric substrate with anti-viral molecules, particularly cationic groups such as quaternary ammonium cationic hydrocarbon groups bonded to the fabric. U.S. Pat. No. 5,851,395 is directed at a virus filter comprising a filter material onto which is deposited a virus-capturing material based on sialic acid (9-carbon monosaccharides having a carboxylic acid substituent on the ring). U.S. Pat. No. 6,182,659 discloses a virus-removing filter based on a Streptococcus agalactiae culture product. U.S. Pat. No. 6,190,437 discloses an air filter for removing virus from the air comprising a carrier substrate impregnated with iodine resins. U.S. Pat. No. 6,379,794 discloses filters based on glass and other high modulus fibers impregnated with an acrylic latex material. U.S. Pat. No. 6,551,608 discloses a porous thermoplastic material substrate and an antiviral substance made by sintering at least one antiviral agent with the thermoplastic substance. U.S. Pat. No. 7,029,516 discloses a filter system for removing particles from a fluid comprising a non-woven polypropylene base upon which is deposited an acidic polymer such as polyacrylic acid.

There is an ongoing and highly urgent need to improve such filters, particularly in view of concerns about the risks from “bird flu” and corona virus. The present inventors have identified filter materials which may be capable of increasing the level of removal of harmful virus and/or other micro-organisms from inhaled air and neutralization of these species, enabling the use of such materials in an improved nasal and/or mouth filter. The same filter materials may also be used as a filtration member in other filter devices, such as those for purification of water and air, separation of selected solvents, and recovery of spilled oil.

### SUMMARY

The present disclosure provides a face mask comprising: (a) a mask body configured to cover at least wearer's mouth and nose; and (b) a fastener to hold the mask in place on the wearer's face (e.g. a pair of ear straps that extend from both sides of the mask body and are configured to be hooked around wearer's ears, or an elastic strap that is hooked around wearer's head); wherein the mask body includes (i) an air-permeable outer layer (e.g. a fiber sheet or piece of fabric, or a porous polymer membrane) preferably comprising a hydrophobic material (e.g. water-repelling fibers), (ii) an inner layer located on a wearer's side when the mask is worn, and (iii) a graphene foam layer disposed in the mask body. In one embodiment the graphene foam layer is disposed between the outer layer and the inner layer. In another embodiment the graphene foam layer is embedded in the outer layer. In another embodiment the graphene foam layer is embedded in the inner layer. The graphene foam layer may be totally or partially embedded in the outer layer or in the inner layer. The graphene foam layer may comprises a graphene material selected from pristine graphene, graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

In certain embodiments, the graphene foam layer is chemically bonded to a surface (e.g. the inner surface) of the outer layer or a surface (the surface facing the outer layer) of the inner layer using an adhesive or binder.

In the disclosed face mask, the graphene foam layer preferably has a density from 0.005 to 1.0 g/cm³ or a specific surface area from 40 to 2,600 m²/g, but further preferably a specific surface area from 200 to 2,000 m²/g or a density from 0.01 to 0.5 g/cm³.

The graphene foam layer-to-outer layer weight ratio or the graphene foam layer-to-inner layer weight ratio is preferably from 1/1000 to 1/0.1, more preferably from 1/100 to 1/1, and most preferably from 5/100 to 25/100.

In some embodiments, the graphene foam layer is a discrete layer that is embedded in at least one of the outer layer or the inner layer.

In the disclosed face mask, the outer layer or the inner layer may of the mask body comprise a woven or nonwoven structure of polymer or glass fibers. The outer layer or the inner layer may preferably comprise polymer fibers selected from the group of cotton, cellulose, wool, polyolefins (e.g. polyethylene and polypropylene), polyester (e.g. PET), polyamide (e.g. nylon), rayon, polyacrylonitrile, cellulose acetate, polystyrene, polyvinyls, poly (carboxylic acid), a biodegradable polymer, a water-soluble polymer, copolymers thereof, and combinations thereof.

The fastener may comprise a pair of ear straps that extend from both sides of the mask body and are configured to be hooked around wearer's ears, or an elastic strap that is hooked around wearer's head.

Preferably, the graphene foam layer has an oxygen content from 5% to 50% by weight based on the total graphene sheet weight. The oxygen-containing functional groups on graphene surfaces appear to be capable of killing or de-activating certain microbial agents.

In the disclosed face mask, the mask body may further comprise an anti-microbial compound. Preferably, the mask body further comprises an anti-microbial compound distributed on pore wall surfaces of the graphene foam. With such a high specific surface area, the mask body enables a dramatically higher surface of the anti-microbial compound that can directly attack the microbial pathogens (bacteria, virus, etc.)

The anti-microbial compound may comprise an antiviral or anti-bacteria compound selected from acrylic acid, methacrylic acid, citric acid, an acidic polymer, a silver-organic idine antibacterial agent, an iodine resin, a sialic acid (e.g. 9-carbon monosaccharides having a carboxylic acid substituent on the ring), a cationic group (e.g. quaternary ammonium cationic hydrocarbon group bonded to the fabric or graphene sheets), a sulfonamide, a fluoroquinolone, or a combination thereof.

The present disclosure also provides a filtration material (or member) for use in the aforementioned face mask or other types of filtration devices. In certain embodiments, the filtration material comprises a layer of woven or nonwoven fabric having two primary surfaces and a graphene foam layer deposited on at least one of the two primary surfaces, or embedded in the layer of woven or nonwoven fabric.

In the filtration material, the graphene foam layer preferably comprises a graphene material selected from pristine graphene, graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof. In some embodiments, the graphene sheets are chemically bonded to the at least one of the primary surfaces, with or without using an adhesive or binder. In the filtration material, the graphene layer preferably has a density from 0.005 to 1.0 g/cm³, or a specific surface area from 10 to 2,600 m²/g and further preferably has a specific surface area from 200 to 2,000 m²/g or a density from 0.1 to 1.2 g/cm³. The specific surface area of the foam is most desirably higher than 300 m²/g.

In the filtration material, the graphene foam layer is preferably a discrete layer that is partially or totally embedded in the layer of woven or nonwoven fabric.

The disclosure further provides a filtration device comprising the disclosed filtration material as a filtration member. The filtration device may be a water-purifying device, an air-purifying device, an oil-recovering device, or a solvent-removing device.

### BRIEF DESCRIPTION OF THE DRAWINGS

FIG. 1 A flow chart showing the most commonly used prior art process for producing graphene sheets.

FIG .2 Schematic of a face mask according to an embodiment of the present disclosure.

FIG. 3(A) Schematic of a face mask structure according to an embodiment wherein the graphene layer is a discrete layer that is embedded in the outer layer.

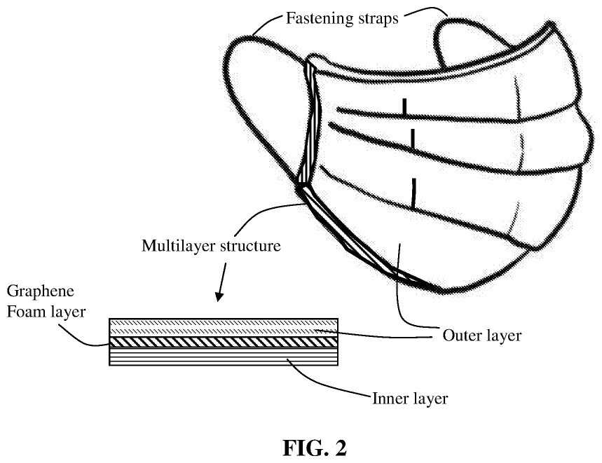

FIG. 3(B) Schematic of a face mask structure according to an embodiment wherein the graphene layer is a discrete layer that is embedded in the inner layer.

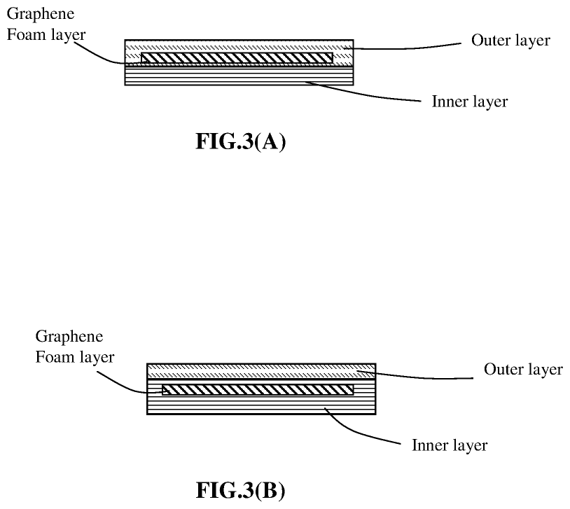

### DESCRIPTION OF THE PREFERRED EMBODIMENTS

The present disclosure provides a filtration element (member) and a filtration device containing such a member. The filtration device may be selected from a water filter device, an air filter device, a solvent purification device, an oil-recovering device, or a face mask.

In certain embodiments, as schematically illustrated in FIG. 2, the disclosed face mask comprises: (a) a mask body configured to cover at least wearer's mouth and nose; and (b) a fastener to hold the mask in place on the wearer's face (e.g. a pair of ear straps that extend from both sides of the mask body and are configured to be hooked around wearer's ears, or an elastic strap that is hooked around wearer's head); wherein the mask body includes (i) an air-permeable outer layer (e.g. a fiber sheet or piece of fabric) comprising a hydrophobic material (e.g. water-repelling fibers), (ii) an inner layer located on a wearer's side when the mask is worn, and (iii) a layer of graphene foam disposed between the outer layer and the inner layer or totally or partially embedded in the outer layer or in the inner layer.

The graphene foam layer preferably comprises a graphene material selected from pristine graphene, graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof. Face masks include surgical masks, respirators, and non-medical masks, etc.

The outer layer or the inner layer may be each a multi-ply or multi-layer structure. In some embodiments, a graphene layer may be embedded as one of the multiple layers in the outer layer or the inner layer. The air-permeable structure may comprise a fibrous substrate or fabric, which can either be a woven or non-woven fabric. Examples of woven materials include those natural and synthetic fibers such as cotton, cellulose, wool, polyolefins (e.g. PE and PP), polyester (e.g. PET and PBT), polyamide (e.g. nylon), rayon, polyacrylonitrile, cellulose acetate, polystyrene, polyvinyls and any other synthetic polymers that can be processed into fibers. Examples of non-woven materials include polypropylene, polyethylene, polyester, nylon, PET and PLA. For the presently disclosed device, non-woven is preferred, which may be in the form of a non-woven sheet or pad.

Non-woven polyester is a preferred air-permeable structure because some of the desired anti-viral or anti-bacteria compounds, such as an acidic polymer, adhere better to polyester material. Also preferred is polypropylene non-woven fabric. The graphene foam structures investigated herein appear to be compatible with all the polymeric fiber-based fabric structures. The grade of fibrous substrate or fabric which may be used to support graphene foam may be determined by practice to achieve a suitable through-flow of air, and the density may be as known from the face-mask art to provide a mask of a comfortable weight.

Non-woven polypropylene of the type conventionally used for surgical masks and the like is widely available in sheet form. Suitable grades of non-woven polypropylene include the well-known grades commonly used for surgical face masks. Typical non-woven polypropylene materials found suitable for use in the face mask or other filtration devices have areal weights of 10-50 g/m² (gsm). Other suitable material weights can be determined empirically. Typical non-woven polyester suitable for use in the filtration devices has areal weights of 10-300 g/m². For face mask applications, polyester materials of weight 20-100 g/m² are preferred. Such materials are commercially available. Other suitable materials may be determined empirically without difficulty.

Alternatively, the porous layer substrate, other than non-woven or woven fabric, may be in other forms such as an open-cell foam, e.g. a polyurethane foam as is also used for air filters. A graphene foam layer and a polymer foam layer are then bonded or laminated together to form a body of structural integrity.

Again, face masks, including surgical masks and respirators, are commonly made with non-woven fabric, which has better bacteria filtration and air permeability while remaining less slippery than woven cloth. The material most commonly used to make them is polypropylene, but again can also be made of polystyrene, polycarbonate, polyethylene, or polyester, etc. The mask material of 20 g/m² or gsm is typically made in a spun-bond process, which involves extruding the melted plastic onto a conveyor. The material is extruded in a web, in which strands bond with each other as they cool. The 25 gsm fabric is typically made through the melt-blown process, wherein plastic is extruded through a die with hundreds of small nozzles and blown by hot air to become ultra-small fibers, cooling and binding on a conveyor. These fibers are typically less than a micron in diameter. A graphene foam layer may be combined with the plastic fabric during or after the fabric production procedure.

Surgical masks are composed of a multi-layered structure, generally by covering a layer of textile with non-woven bonded fabric on both sides. Non-woven materials are less expensive to make and cleaner due to their disposable nature. The structure incorporated as part of a mask body may be made with three or four layers. These disposable masks are often made with two filter layers effective in filtering out particles, such as bacteria above 1 micron. The filtration level of a mask depends on the fiber, the manufacturing process, the web structure, and the cross-sectional shape of the fiber. In the disclosed mask, the graphene foam layer can be incorporated as one of the multi-layers, but preferably not directly exposed to the outside air (not the outermost layer) and not directly in contact with the face of the wearer (not the inner-most layer). Masks may be made on a machine line that assembles the nonwovens from bobbins, ultrasonically welds the layers together, and stamps the masks with nose strips, ear loops, and other pieces. These procedures are well-known in the art.

Respirators also comprise multiple layers. The outer layer on both sides may be made of a protective nonwoven fabric between 20 and 100 g/m² density to create a barrier both against the outside environment and, on the inside, against the wearer's own exhalations. A pre-filtration layer follows which can be as dense as 250 g/m². This is usually a needled nonwoven which is produced through hot calendaring, in which plastic fibers are thermally bonded by running them through high pressure heated rolls. A graphene foam layer may be used to partially or totally replace this layer. In the case of partial substitution, graphene foam sheets may be bonded onto a primary surface of this needled nonwoven layer. This makes the pre-filtration layer thicker and stiffer to form the desired shape as the mask is used. The last layer may be a high efficiency melt-blown electret nonwoven material, which determines the filtration efficiency. This melt-blown layer, instead of or in addition to the pre-filtration layer, may be bonded with a graphene foam layer.

The pore wall graphene surfaces in graphene foam may be deposited with an anti-viral or anti-bacterial compound. This deposition may be conducted before or after the graphene sheets form into a graphene layer. The anti-microbial compound may comprise an antiviral or anti-bacteria compound selected from acrylic acid, methacrylic acid, citric acid, an acidic polymer, a silver-organic idine antibacterial agent, an iodine resin, a sialic acid (e.g. 9-carbon monosaccharides having a carboxylic acid substituent on the ring), a cationic group (e.g. quaternary ammonium cationic hydrocarbon group bonded to the fabric or graphene sheets), a sulfonamide, a fluoroquinolone, or a combination thereof.

It is imperative that face masks and respirators produced are sterilized before being sent out of the factory.

The production of graphene and graphene foam is well-known in the art, but may be further described below for the convenience of the reader: Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In other words, graphene planes (hexagonal lattice structure of carbon atoms) constitute a significant portion of a graphite particle.

A single-layer graphene sheet is composed of carbon atoms occupying a two-dimensional hexagonal lattice. Multi-layer graphene is a platelet composed of more than one graphene plane. Individual single-layer graphene sheets and multi-layer graphene platelets are herein collectively called nano graphene platelets (NGPs) or graphene materials. NGPs include pristine graphene (essentially 99% of carbon atoms), slightly oxidized graphene (<5% by weight of oxygen), graphene oxide (≥5% by weight of oxygen), slightly fluorinated graphene (<5% by weight of fluorine), graphene fluoride ((≥5% by weight of fluorine), other halogenated graphene, and chemically functionalized graphene.

Our research group was among the first to discover graphene [B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. The processes for producing NGPs and NGP nanocomposites were recently reviewed by us [Bor Z. Jang and A Zhamu, “Processing of Nano Graphene Platelets (NGPs) and NGP Nanocomposites: A Review,” J. Materials Sci. 43 (2008) 5092-5101]. The production of various types of graphene sheets is well-known in the art.

For instance, the chemical processes for producing graphene sheets or platelets typically involve immersing powder of graphite or other graphitic material in a mixture of concentrated sulfuric acid, nitric acid, and an oxidizer, such as potassium permanganate or sodium perchlorate, forming a reacting mass that requires typically 5-120 hours to complete the chemical intercalation/oxidation reaction. Once the reaction is completed, the slurry is subjected to repeated steps of rinsing and washing with water. The purified product is commonly referred to as graphite intercalation compound (GIC) or graphite oxide (GO). The suspension containing GIC or GO in water may be subjected to ultrasonication to produce isolated/separated graphene oxide sheets dispersed in water. The resulting products are typically highly oxidized graphene (i.e. graphene oxide with a high oxygen content), which must be chemically or thermal reduced to obtain reduced graphene oxide (RGO).

Alternatively, the GIC suspension may be subjected to drying treatments to remove water. The dried powder is then subjected to a thermal shock treatment. This can be accomplished by placing GIC in a furnace pre-set at a temperature of typically 800-1100° C. (more typically 950-1050° C.) to produce exfoliated graphite (or graphite worms), which may be subjected to a high shear or ultrasonication treatment to produce isolated graphene sheets.

Alternatively, graphite worms may be re-compressed into a film form to obtain a flexible graphite sheet. Flexible graphite sheets are commercially available from many sources worldwide.

The starting graphitic material may be selected from natural graphite, synthetic graphite, highly oriented pyrolytic graphite, graphite fiber, graphitic nano-fiber, graphite fluoride, chemically modified graphite, meso-carbon micro-bead, partially crystalline graphite, or a combination thereof.

Pristine graphene sheets may be produced by the well-known liquid phase exfoliation or metal-catalyzed chemical vapor deposition (CVD).

Graphene films, flexible graphite sheets, and artificial graphite films are commonly regarded as three fundamentally different and patently distinct classes of materials.

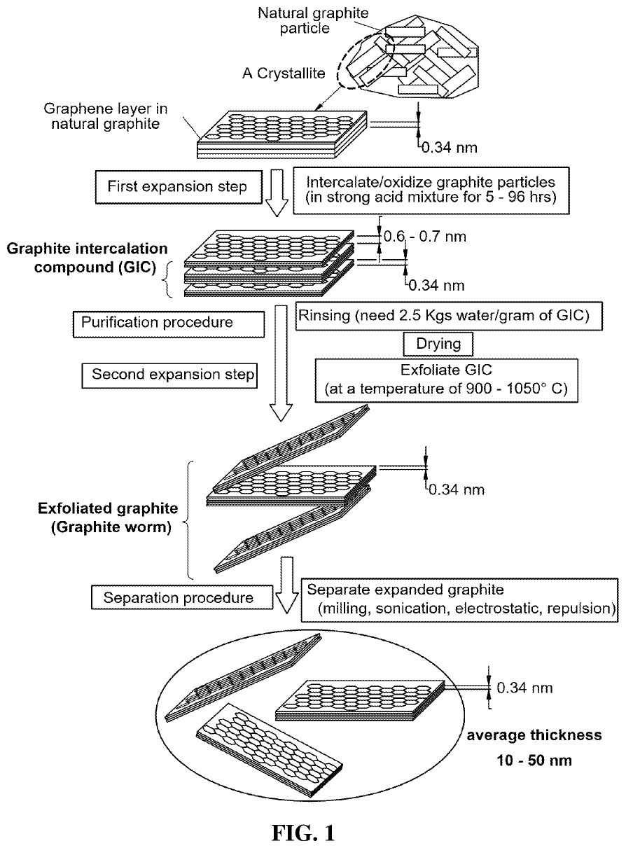

As schematically illustrated in the upper portion of FIG. 1, bulk natural graphite is a 3-D graphitic material with each graphite particle being composed of multiple grains (a grain being a graphite single crystal or crystallite) with grain boundaries (amorphous or defect zones) demarcating neighboring graphite single crystals. Each grain is composed of multiple graphene planes that are oriented parallel to one another. A graphene plane or hexagonal carbon atom plane in a graphite crystallite is composed of carbon atoms occupying a two-dimensional, hexagonal lattice. In a given grain or single crystal, the graphene planes are stacked and bonded via van der Waal forces in the crystallographic c-direction (perpendicular to the graphene plane or basal plane). The inter-graphene plane spacing in a natural graphite material is approximately 0.3354 nm.

Artificial graphite materials also contain constituent graphene planes, but they have an inter-graphene planar spacing, do02, typically from 0.32 nm to 0.36 nm (more typically from 0.3339 to 0.3465 nm), as measured by X-ray diffraction. Many carbon or quasi-graphite materials also contain graphite crystals (also referred to as graphite crystallites, domains, or crystal grains) that are each composed of stacked graphene planes. These include meso-carbon micro-beads (MCMBs), meso-phase carbon, soft carbon, hard carbon, coke (e.g. needle coke), carbon or graphite fibers (including vapor-grown carbon nano-fibers or graphite nano-fibers), and multi-walled carbon nanotubes (MW-CNT). The spacing between two graphene rings or walls in a MW-CNT is approximately 0.27 to 0.42 nm. The most common spacing values in MW-CNTs are in the range from 0.32-0.35 nm, which do not strongly depend on the synthesis method.

It may be noted that the “soft carbon” refers to a carbon material containing graphite domains wherein the orientation of the hexagonal carbon planes (or graphene planes) in one domain and the orientation in neighboring graphite domains are not too mis-matched from each other so that these domains can be readily merged together when heated to a temperature above 2,000° C. (more typically above 2,500° C.). Such a heat treatment is commonly referred to as graphitization. Thus, the soft carbon can be defined as a carbonaceous material that can be graphitized. In contrast, a “hard carbon” can be defined as a carbonaceous material that contain highly mis-oriented graphite domains that cannot be thermally merged together to obtain larger domains; i.e. the hard carbon cannot be graphitized.

The spacing between constituent graphene planes of a graphite crystallite in a natural graphite, artificial graphite, and other graphitic carbon materials in the above list can be expanded (i.e. the d₀₀₂ spacing being increased from the original range of 0.27-0.42 nm to the range of 0.42-2.0 nm) using several expansion treatment approaches, including oxidation, fluorination, chlorination, bromination, iodization, nitrogenation, intercalation, combined oxidation-intercalation, combined fluorination-intercalation, combined chlorination-intercalation, combined bromination-intercalation, combined iodization-intercalation, or combined nitrogenation-intercalation of the graphite or carbon material.

More specifically, due to the van der Waals forces holding the parallel graphene planes together being relatively weak, natural graphite can be treated so that the spacing between the graphene planes can be increased to provide a marked expansion in the c-axis direction. This results in a graphite material having an expanded spacing, but the laminar character of the hexagonal carbon layers is substantially retained. The inter-planar spacing (also referred to as inter-graphene spacing) of graphite crystallites can be increased (expanded) via several approaches, including oxidation, fluorination, and/or intercalation of graphite. The presence of an intercalant, oxygen-containing group, or fluorine-containing group serves to increase the spacing between two graphene planes in a graphite crystallite.

The inter-planar spaces between certain graphene planes may be significantly increased (actually, exfoliated) if the graphite/carbon material having expanded d spacing is exposed to a thermal shock (e.g. by rapidly placing this carbon material in a furnace pre-set at a temperature of typically 800-2,500° C.) without constraint (i.e. being allowed to freely increase volume). Under these conditions, the thermally exfoliated graphite/carbon material appears like worms, wherein each graphite worm is composed of many graphite flakes remaining interconnected. However, these graphite flakes have inter-flake pores typically in the pore size range of 20 nm to 10 μm.

Alternatively, the intercalated, oxidized, or fluorinated graphite/carbon material having expanded d spacing may be exposed to a moderate temperature (100-800° C.) under a constant-volume condition for a sufficient length of time. The conditions may be adjusted to obtain a product of limited exfoliation, having inter-flake pores of 2-20 nm in average size. This is herein referred to as a constrained expansion/exfoliation treatment. We have surprisingly observed that an Al cell having a cathode of graphite/carbon having inter-planar spaces 2-20 nm is capable of delivering a high energy density, high power density, and long cycle life.

In one process, graphite materials having an expanded inter-planar spacing are obtained by intercalating natural graphite particles with a strong acid and/or an oxidizing agent to obtain a graphite intercalation compound (GIC) or graphite oxide (GO). The presence of chemical species or functional groups in the interstitial spaces between graphene planes serves to increase the inter-graphene spacing, d₀₀₂, as determined by X-ray diffraction, thereby significantly reducing the van der Waals forces that otherwise hold graphene planes together along the c-axis direction. The GIC or GO is most often produced by immersing natural graphite powder in a mixture of sulfuric acid, nitric acid (an oxidizing agent), and another oxidizing agent (e.g. potassium permanganate or sodium perchlorate). The resulting GIC is actually some type of graphite oxide (GO) particles if an oxidizing agent is present during the intercalation procedure. This GIC or GO is then repeatedly washed and rinsed in water to remove excess acids, resulting in a graphite oxide suspension or dispersion, which contains discrete and visually discernible graphite oxide particles dispersed in water.

Water may be removed from the suspension to obtain “expandable graphite,” which is essentially a mass of dried GIC or dried graphite oxide particles. The inter-graphene spacing, d₀₀₂, in the dried GIC or graphite oxide particles is typically in the range from 0.42-2.0 nm, more typically in the range from 0.5-1.2 nm. It may be noted than the “expandable graphite” is not “expanded graphite”.

Upon exposure of expandable graphite to a temperature in the range from typically 800-2,500° C. (more typically 900-1,050° C.) for approximately 30 seconds to 2 minutes, the GIC undergoes a rapid volume expansion by a factor of 30-300 to form “exfoliated graphite” or “graphite worms”, Graphite worms are each a collection of exfoliated, but largely un-separated graphite flakes that remain interconnected. In exfoliated graphite, individual graphite flakes (each containing 1 to several hundred of graphene planes stacked together) are highly spaced from one another, having a spacing of typically 2.0 nm-10 μm. However, they remain physically interconnected, forming an accordion or worm-like structure.

In graphite industry, graphite worms can be re-compressed to obtain flexible graphite sheets or foils that typically have a thickness in the range from 0.1 mm (100 μm)-0.5 mm (500 μm). Such flexible graphite sheets may be used as a type of graphitic heat spreader element.

Alternatively, in graphite industry, one may choose to use a low-intensity air mill or shearing machine to simply break up the graphite worms for the purpose of producing the so-called “expanded graphite” flakes which contain mostly graphite flakes or platelets thicker than 100 nm (hence, not a nano material by definition). It is clear that the “expanded graphite” is not “expandable graphite” and is not “exfoliated graphite worm” either. Rather, the “expandable graphite” can be thermally exfoliated to obtain “graphite worms,” which, in turn, can be subjected to mechanical shearing to break up the otherwise interconnected graphite flakes to obtain “expanded graphite” flakes. Expanded graphite flakes typically have the same or similar inter-planar spacing (typically 0.335-0.36 nm) of their original graphite. Multiple expended graphite flakes may be roll-pressed together to form graphitic films, which are a variation of flexible graphite sheets.

Alternatively, the exfoliated graphite or graphite worms may be subjected to high-intensity mechanical shearing (e.g. using an ultrasonicator, high-shear mixer, high-intensity air jet mill, or high-energy ball mill) to form separated single-layer and multi-layer graphene sheets (collectively called NGPs), as disclosed in our U.S. application Ser. No. 10/858,814 (U.S. Pat. Pub. No. 2005/0271574) (now abandoned). Single-layer graphene can be as thin as 0.34 nm, while multi-layer graphene can have a thickness up to 100 nm, but more typically less than 3 nm (commonly referred to as few-layer graphene). Multiple graphene sheets or platelets may be made into a sheet of NGP paper using a paper-making process.

In GIC or graphite oxide, the inter-graphene plane separation has been increased from 0.3354 nm in natural graphite to 0.5-1.2 nm in highly oxidized graphite oxide, significantly weakening the van der Waals forces that hold neighboring planes together. Graphite oxide can have an oxygen content of 2%-50% by weight, more typically 20%-40% by weight. GIC or graphite oxide may be subjected to a special treatment herein referred to as “constrained thermal expansion”. If GIC or graphite oxide is exposed to a thermal shock in a furnace (e.g. at 800-1,050° C.) and allowed to freely expand, the final product is exfoliated graphite worms. However, if the mass of GIC or graphite oxide is subjected to a constrained condition (e.g. being confined in an autoclave under a constant volume condition or under a uniaxial compression in a mold) while being slowly heated from 150° C. to 800° C. (more typically up to)600° for a sufficient length of time (typically 2 minutes to 15 minutes), the extent of expansion can be constrained and controlled, and the product can have inter-flake spaces from 2.0 nm to 20 nm, or more desirably from 2 nm to 10 nm.

It may be noted that the “expandable graphite” or graphite with expanded inter-planar spacing may also be obtained by forming graphite fluoride (GF), instead of GO. Interaction of F₂ with graphite in a fluorine gas at high temperature leads to covalent graphite fluorides, from (CF)ₙ to (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated consisting of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents (e.g. mixtures of F₂ with Br₂, Cl₂, or I₂) may be used, although most of the available literature involves fluorination with F₂ gas, sometimes in presence of fluorides.

We have observed that lightly fluorinated graphite, CₓF (2≤x≤24), obtained from electrochemical fluorination, typically has an inter-graphene spacing (d₀₀₂) less than 0.37 nm, more typically <0.35 nm. Only when x in CₓF is less than 2 (i.e. 0.5≤x<2) can one observe a d₀₀₂ spacing greater than 0.5 nm (in fluorinated graphite produced by a gaseous phase fluorination or chemical fluorination procedure). When x in CₓF is less than 1.33 (i.e. 0.5≤x<1.33) one can observe a d₀₀₂ spacing greater than 0.6 nm. This heavily fluorinated graphite is obtained by fluorination at a high temperature (>>200° C.) for a sufficiently long time, preferably under a pressure >1 atm, and more preferably >3 atm. For reasons remaining unclear, electrochemical fluorination of graphite leads to a product having a d spacing less than 0.4 nm even though the product CₓF has an x value from 1 to 2. It is possible that F atoms electrochemically introduced into graphite tend to reside in defects, such as grain boundaries, instead of between graphene planes and, consequently, do not act to expand the inter-graphene planar spacing.

The nitrogenation of graphite can be conducted by exposing a graphite oxide material to ammonia at high temperatures (200-400° C.). Nitrogenation may also be conducted at lower temperatures by a hydrothermal method; e.g. by sealing GO and ammonia in an autoclave and then increased the temperature to 150-250° C.

In addition to N, O, F, Br, Cl, or H, the presence of other chemical species (e.g. Na, Li, K, Ce, Ca, Fe, NH₄, etc.) between graphene planes can also serve to expand the inter-planar spacing, creating room to accommodate electrochemically active materials therein. The expanded interstitial spaces between graphene planes (hexagonal carbon planes or basal planes) are found by us in this study to be surprisingly capable of accommodating Al⁺³ ions and other anions (derived from electrolyte ingredients) as well, particularly when the spaces are from 2.0 nm to 20 nm. It may be noted that graphite can electrochemically intercalated with such chemical species as Na, Li, K, Ce, Ca, NH₄, or their combinations, which can then be chemically or electrochemically ion-exchanged with metal elements (Bi, Fe, Co, Mn, Ni, Cu, etc.). All these chemical species can serve to expand the inter-planar spacing. The spacing may be dramatically expanded (exfoliated) to have inter-flake pores that are 20 nm-10 μm in size.

Generally speaking, a foam or foamed material is composed of pores (or cells) and pore walls (a solid material). The pores can be interconnected to form an open-cell foam, which is preferred to a closed-cell foam in practicing instant disclosure. A graphene foam is composed of pores and pore walls that contain a graphene material. There are four major methods of producing graphene foams:

The first method is the hydrothermal reduction of graphene oxide hydrogel that typically involves sealing graphene oxide (GO) aqueous suspension in a high-pressure autoclave and heating the GO suspension under a high pressure (tens or hundreds of atm) at a temperature typically in the range from 180-300° C. for an extended period of time (typically 12-36 hours). A useful reference for this method is given here: Y. Xu, et al. “Self-Assembled Graphene Hydrogel via a One-Step Hydrothermal Process,” ACS Nano 2010, 4, 4324-4330.

The second method is based on a template-assisted catalytic CVD process, which involves CVD deposition of graphene on a sacrificial template (e.g. Ni foam). The graphene material conforms to the shape and dimensions of the Ni foam structure. The Ni foam is then etched away using an etching agent, leaving behind a monolith of graphene skeleton that is essentially an open-cell foam. A useful reference for this method is given here: Zongping Chen, et al., “Three-dimensional flexible and conductive interconnected graphene networks grown by chemical vapour deposition,” Nature Materials, 10 (June 2011) 424-428.

The third method of producing graphene foam also makes use of a sacrificial material (e.g. colloidal polystyrene particles, PS) that is coated with graphene oxide sheets using a self-assembly approach. For instance, Choi, et al. prepared chemically modified graphene (CMG) paper in two steps: fabrication of free-standing PS/CMG films by vacuum filtration of a mixed aqueous colloidal suspension of CMG and PS (2.0 μm PS spheres), followed by removal of PS beads to generate 3D macro-pores. [B. G. Choi, et al., “3D Macroporous Graphene Frameworks for Supercapacitors with High Energy and Power Densities,” ACS Nano, 6 (2012) 4020-4028.] Choi, et al. fabricated well-ordered free-standing PS/CMG paper by filtration, which began with separately preparing a negatively charged CMG colloidal and a positively charged PS suspension. A mixture of CMG colloidal and PS suspension was dispersed in solution under controlled pH (=2), where the two compounds had the same surface charges (zeta potential values of +13±2.4 mV for CMG and +68±5.6 mV for PS). When the pH was raised to 6, CMGs (zeta potential =−29±3.7 mV) and PS spheres (zeta potential =+51±2.5 mV) were assembled due to the electrostatic interactions and hydrophobic characteristics between them, and these were subsequently integrated into PS/CMG composite paper through a filtering process.

The fourth method for producing a solid graphene foam composed of multiple pores and pore walls was invented by us earlier [Aruna Zhamu and Bor Z. Jang, “Highly Conductive Graphene Foams and Process for Producing Same,” U.S. patent application Ser. No. 14/120,959 (Jul. 17, 2014)]. The process comprises:

(a) preparing a graphene dispersion having a graphene material dispersed in a liquid medium, wherein the graphene material is selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof and wherein the dispersion contains an optional blowing agent;

(b) dispensing and depositing the graphene dispersion onto a surface of a supporting substrate (e.g. plastic film, rubber sheet, metal foil, glass sheet, paper sheet, etc.) to form a wet layer of graphene material, wherein the dispensing and depositing procedure includes subjecting the graphene dispersion to an orientation-inducing stress;

(c) partially or completely removing the liquid medium from the wet layer of graphene material to form a dried layer of graphene material having a content of non-carbon elements (e.g. O, H, N, B, F, Cl, Br, I, etc.) no less than 5% by weight; and

(d) heat treating the dried layer of graphene material at a first heat treatment temperature from 100° C. to 3,200° C. at a desired heating rate sufficient to induce volatile gas molecules from the non-carbon elements or to activate said blowing agent for producing the solid graphene foam having a density from 0.01 to 1.7 g/cm³ (more typically from 0.1 to 1.5 g/cm³, and even more typically from 0.1 to 1.0 g/cm³, and most typically from 0.2 to 0.75 g/cm³), or a specific surface area from 50 to 3,000 m²/g (more typically from 200 to 2,000 m²/g, and most typically from 500 to 1,500 m²/g).

This optional blowing agent is not required if the graphene material has a content of non-carbon elements (e.g. O, H, N, B, F, Cl, Br, I, etc.) no less than 5% by weight (preferably no less than 10%, further preferably no less than 20%, even more preferably no less than 30% or 40%, and most preferably up to 50%). The subsequent high temperature treatment serves to remove a majority of these non-carbon elements from the graphene material, generating volatile gas species that produce pores or cells in the solid graphene material structure. In other words, quite surprisingly, these non-carbon elements play the role of a blowing agent. Hence, an externally added blowing agent is optional (not required). However, the use of a blowing agent can provide added flexibility in regulating or adjusting the porosity level and pore sizes for a desired application. The blowing agent is typically required if the non-carbon element content is less than 5%, such as pristine graphene that is essentially all-carbon.

The graphene foam produced by the fourth method has the highest thermal conductivity among all graphene foam materials, and also exhibit a highly reversible and durable elastic deformation under tension or compression, enabling good, long-term contact between fabric layers of a filtration member or filtration device.

The process of making face masks may comprise incorporating the graphene foam filtration material (member) into a mask body, which is fitted with a fastener (e.g. elastic straps) to form the face mask.

The graphene foam can be made to contain microscopic pores (<2 nm), meso-scaled pores having a pore size from 2 nm to 50 nm, or larger pores (preferably 50 nm to 1 μm). Based on well-controlled pore size alone, the instant graphene foam supported by a fabric can be an exceptional filter material for air or water filtration.

Further, the graphene pore wall surface chemistry can be independently controlled to impart different amounts and/or types of functional groups to graphene sheets (e.g. as reflected by the percentage of O, F, N, H, etc. in the sheets). In other words, the concurrent or independent control of both pore sizes and chemical functional groups at different sites of the internal structure provide unprecedented flexibility or highest degree of freedom in designing and making graphene-coated fabric that exhibits many unexpected properties, synergistic effects, and some unique combination of properties that are normally considered mutually exclusive (e.g. some part of the structure is hydrophobic and other part hydrophilic; or the filtration structure is both hydrophobic and oleophilic). A surface or a material is said to be hydrophobic if water is repelled from this material or surface and that a droplet of water placed on a hydrophobic surface or material will form a large contact angle. A surface or a material is said to be oleophilic if it has a strong affinity for oils and not for water. The present method allows for precise control over hydrophobicity, hydrophilicity, and oleophilicity.

The present disclosure also provides an oil-removing, oil-separating, or oil-recovering device, which contains the presently invented graphene foam layer-bonded fabric as an oil-absorbing or oil-separating element. Also provided is a solvent-removing or solvent-separating device containing the graphene foam layer-bonded fabric as a solvent-absorbing element.

A major advantage of using the instant graphene foam-bonded fabric structure as an oil-absorbing element is its structural integrity. Due to the notion that graphene foam can be of high structural integrity and the foam structure may be chemically bonded by an adhesive to a fabric layer, the resulting structure would not get disintegrated upon repeated oil absorption operations.

Another major advantage of the instant technology is the flexibility in designing and making oil-absorbing elements that are capable of absorbing oil up to a large amount yet still maintaining its structural shape (without significant expansion). This amount depends upon the specific pore volume of the filtration structure.

The disclosure also provides a method to separate/recover oil from an oil-water mixture (e.g. oil-spilled water or waste water from oil sand). The method comprises the (a) providing an oil-absorbing element comprising a graphene foam layer-bonded fabric; (b) contacting an oil-water mixture with the element, which absorbs the oil from the mixture; and (c) retreating the oil-absorbing element from the mixture and extracting the oil from the element. Preferably, the method comprises (d) reusing the element.

Additionally, the disclosure provides a method to separate an organic solvent from a solvent-water mixture or from a multiple-solvent mixture. The method comprises (a) providing an organic solvent-absorbing element comprising an integral graphene form layer-bonded fabric structure; (b) bringing the element in contact with an organic solvent-water mixture or a multiple-solvent mixture containing a first solvent and at least a second solvent; (c) allowing this element to absorb the organic solvent from the mixture or absorb the first solvent from the at least second solvent; and (d) retreating the element from the mixture and extracting the organic solvent or first solvent from the element. Preferably, the method contains (e) of reusing the solvent-absorbing element.

The following examples are used to illustrate some specific details about the best modes of practicing the instant disclosure and should not be construed as limiting the scope of the disclosure.

### EXAMPLE 1

### Various Blowing Agents and Pore-Forming (Bubble-Producing) Processes

In the field of plastic processing, chemical blowing agents are mixed into the plastic pellets in the form of powder or pellets and dissolved at higher temperatures. Above a certain temperature specific for blowing agent dissolution, a gaseous reaction product (usually nitrogen or CO₂) is generated, which acts as a blowing agent. However, a chemical blowing agent cannot be dissolved in a graphene material, which is a solid, not liquid. This presents a challenge to make use of a chemical blowing agent to generate pores or cells in a graphene material.

After extensive experimenting, we have discovered that practically any chemical blowing agent (e.g. in a powder or pellet form) can be used to create pores or bubbles in a dried layer of graphene when the first heat treatment temperature is sufficient to activate the blowing reaction. The chemical blowing agent (powder or pellets) may be dispersed in the liquid medium to become a second dispersed phase (sheets of graphene material being the first dispersed phase) in the suspension, which can be deposited onto the solid supporting substrate to form a wet layer. This wet layer of graphene material may then be dried and heat treated to activate the chemical blowing agent. After a chemical blowing agent is activated and bubbles are generated, the resulting foamed graphene structure is largely maintained even when subsequently a higher heat treatment temperature is applied to the structure. This is quite unexpected, indeed.

Chemical foaming agents (CFAs) can be organic or inorganic compounds that release gasses upon thermal decomposition. CFAs are typically used to obtain medium- to high-density foams, and are often used in conjunction with physical blowing agents to obtain low-density foams. CFAs can be categorized as either endothermic or exothermic, which refers to the type of decomposition they undergo. Endothermic types absorb energy and typically release carbon dioxide and moisture upon decomposition, while the exothermic types release energy and usually generate nitrogen when decomposed. The overall gas yield and pressure of gas released by exothermic foaming agents is often higher than that of endothermic types. Endothermic CFAs are generally known to decompose in the range from 130 to 230° C. (266-446° F.), while some of the more common exothermic foaming agents decompose around 200° C. (392° F.). However, the decomposition range of most exothermic CFAs can be reduced by addition of certain compounds. The activation (decomposition) temperatures of CFAs fall into the range of our heat treatment temperatures. Examples of suitable chemical blowing agents include sodium bi-carbonate (baking soda), hydrazine, hydrazide, azodicarbonamide (exothermic chemical blowing agents), nitroso compounds (e.g. N, N-Dinitroso pentamethylene tetramine), hydrazine derivatives (e.g. 4.4′-Oxybis (benzenesulfonyl hydrazide) and Hydrazo dicarbonamide), and hydrogen carbonate (e.g. Sodium hydrogen carbonate). These are all commercially available in plastics industry.

In the production of foamed plastics, physical blowing agents are metered into the plastic melt during foam extrusion or injection molded foaming, or supplied to one of the precursor materials during polyurethane foaming. It has not been previously known that a physical blowing agent can be used to create pores in a graphene material, which is in a solid state (not melt). We have surprisingly observed that a physical blowing agent (e.g. CO₂ or N₂) can be injected into the stream of graphene suspension prior to being coated or cast onto the supporting substrate. This would result in a foamed structure even when the liquid medium (e.g. water and/or alcohol) is removed. The dried layer of graphene material is capable of maintaining a controlled amount of pores or bubbles during liquid removal and subsequent heat treatments.

Technically feasible blowing agents include Carbon dioxide (CO₂), Nitrogen (N₂), Isobutane (C₄H₁₀), Cyclopentane (C₅H₁₀), Isopentane (C₅H₁₂), CFC-11 (CFCI₃), HCFC-22 (CHF₂CI), HCFC-142b (CF₂CICH₃), and HCFC-134a (CH₂FCF₃). However, in selecting a blowing agent, environmental safety is a major factor to consider. The Montreal Protocol and its influence on consequential agreements pose a great challenge for the producers of foam. Despite the effective properties and easy handling of the formerly applied chlorofluorocarbons, there was a worldwide agreement to ban these because of their ozone depletion potential (ODP). Partially halogenated chlorofluorocarbons are also not environmentally safe and therefore already forbidden in many countries. The alternatives are hydrocarbons, such as isobutane and pentane, and the gases such as CO₂ and nitrogen.

Except for those regulated substances, all the blowing agents recited above have been tested in our experiments. For both physical blowing agents and chemical blowing agents, the blowing agent amount introduced into the suspension is defined as a blowing agent-to-graphene material weight ratio, which is typically from 0/1.0 to 1.0/1.0.

### EXAMPLE 2

### Preparation of Discrete Graphene Oxide (GO) Sheets and GO Foam

Chopped graphite fibers with an average diameter of 12 μm and natural graphite particles were separately used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 5-16 hours of reaction, the acid-treated graphite fibers or natural graphite particles were filtered and washed thoroughly with deionized water until the pH level of the solution reached 6. After being dried at 100° C. overnight, the resulting graphite intercalation compound (GIC) or graphite oxide fiber was re-dispersed in water and/or alcohol to form a slurry.

In one sample, five grams of the graphite oxide fibers were mixed with 2,000 ml alcohol solution consisting of alcohol and distilled water with a ratio of 15:85 to obtain a slurry mass. Then, the mixture slurry was subjected to ultrasonic irradiation with a power of 200 W for various lengths of time. After 20 minutes of sonication, GO fibers were effectively exfoliated and separated into thin graphene oxide sheets with oxygen content of approximately 23%-31% by weight. The resulting suspension contains GO sheets being suspended in water. A chemical blowing agent (hydrazo dicarbonamide) was added to the suspension just prior to casting.

The resulting suspension was then cast onto a glass surface using a doctor's blade to exert shear stresses, inducing GO sheet orientations. The resulting GO coating films, after removal of liquid, have a thickness that can be varied from approximately 5 to 500 μm (preferably and typically from 10 μm to 50 μm).

For making a graphene foam specimen, the GO coating film was then subjected to heat treatments that typically involve an initial thermal reduction temperature of 80-350° C. for 0.5-2 hours, followed by heat-treating at a second temperature of 500-1,500° C. for 0.5 to 2 hours to produce GO foam sheets (typically 1-500 μm, but could be thinner or thicker, depending upon GO coating thickness).

### EXAMPLE 3

### Preparation of Single-Layer Graphene Sheets from Meso-Carbon Micro-Beads (MCMBs) and Graphene Foam

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMB s were repeatedly washed in a 5% solution of HC1 to remove most of the sulfate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours.

The GO sheets contain oxygen proportion of approximately 35%-47% by weight for oxidation treatment times of 48-96 hours. GO sheets were suspended in water. Baking soda (5-20% by weight), as a chemical blowing agent, was added to the suspension just prior to casting. The suspension was then cast onto a glass surface using a doctor's blade to exert shear stresses, inducing GO sheet orientations. Several samples were cast, some containing a blowing agent and some not. The resulting GO films, after removal of liquid, have a thickness that can be varied from approximately 10 to 500 μm.

The several sheets of the GO film, with or without a blowing agent, were then subjected to heat treatments that involve an initial (first) thermal reduction temperature of 80-500° C. for 1-2 hours. This first heat treatment generated a graphene foam. However, the graphene domains in the foam wall can be further perfected (re-graphitized to become more ordered or having a higher degree of crystallinity and larger lateral dimensions of graphene planes, longer than the original graphene sheet dimensions due to chemical merging) if the foam is followed by heat-treating at a second temperature of 1,500-2,850° C.

### EXAMPLE 4

### Preparation of Pristine Graphene Foam (0% Oxygen)

Recognizing the possibility of the high defect population in GO sheets acting to reduce the conductivity of individual graphene plane, we decided to study if the use of pristine graphene sheets (non-oxidized and oxygen-free, non-halogenated and halogen-free, etc.) can lead to a graphene foam having a higher thermal conductivity. Pristine graphene sheets were produced by using the direct ultrasonication or liquid-phase production process.

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements.

Various amounts (1%-30% by weight relative to graphene material) of chemical bowing agents (N, N-Dinitroso pentamethylene tetramine or 4. 4′-Oxybis (benzenesulfonyl hydrazide) were added to a suspension containing pristine graphene sheets and a surfactant. The suspension was then cast onto a glass surface using a doctor's blade to exert shear stresses, inducing graphene sheet orientations. Several samples were cast, including one that was made using CO₂ as a physical blowing agent introduced into the suspension just prior to casting). The resulting graphene films, after removal of liquid, have a thickness that can be varied from approximately 10 to 100 μm.

The graphene films were then subjected to heat treatments that involve an initial (first) thermal reduction temperature of 80-1,500° C. for 1-5 hours. This first heat treatment generated a graphene foam. Some of the pristine foam samples were then subjected to a second temperature of 1,500-2,850° C. to determine if the graphene domains in the foam wall could be further perfected (re-graphitized to become more ordered or having a higher degree of crystallinity).

### EXAMPLE 5

### CVD Graphene Foams on Ni Foam Templates

The procedure was adapted from that disclosed in open literature: Chen, Z. et al. “Three-dimensional flexible and conductive interconnected graphene networks grown by chemical vapor deposition,” Nat. Mater. 10, 424-428 (2011). Nickel foam, a porous structure with an interconnected 3D scaffold of nickel was chosen as a template for the growth of graphene foam. Briefly, carbon was introduced into a nickel foam by decomposing CH₄ at 1,000° C. under ambient pressure, and graphene films were then deposited on the surface of the nickel foam. Due to the difference in the thermal expansion coefficients between nickel and graphene, ripples and wrinkles were formed on the graphene films. In order to recover (separate) graphene foam, Ni frame must be etched away. Before etching away the nickel skeleton by a hot HC1 (or FeCl₃) solution, a thin layer of poly(methyl methacrylate) (PMMA) was deposited on the surface of the graphene films as a support to prevent the graphene network from collapsing during nickel etching. After the PMMA layer was carefully removed by hot acetone, a fragile graphene foam sample was obtained. The use of the PMMA support layer is critical to preparing a free-standing film of graphene foam; only a severely distorted and deformed graphene foam sample was obtained without the PMMA support layer.

### EXAMPLE 6

### Preparation of Graphene Oxide (GO) Suspension from Natural Graphite and of Subsequent GO Foams

Graphite oxide was prepared by oxidation of graphite flakes with an oxidizer liquid consisting of sulfuric acid, sodium nitrate, and potassium permanganate at a ratio of 4:1:0.05 at 30° C. When natural graphite flakes (particle sizes of 14 μm) were immersed and dispersed in the oxidizer mixture liquid for 48 hours, the suspension or slurry appears and remains optically opaque and dark. After 48 hours, the reacting mass was rinsed with water 3 times to adjust the pH value to at least 3.0. A final amount of water was then added to prepare a series of GO-water suspensions. We observed that GO sheets form a liquid crystal phase when GO sheets occupy a weight fraction >3% and typically from 5% to 15%.

By dispensing and coating the GO suspension on a polyethylene terephthalate (PET) film in a slurry coater and removing the liquid medium from the coated film we obtained a thin film of dried graphene oxide. Several GO film samples were then subjected to different heat treatments, which typically include a thermal reduction treatment at a first temperature of 100° C. to 500° C. for 1-10 hours, and at a second temperature of 1,500° C.-2,850° C. for 0.5-5 hours. With these heat treatments, also under a compressive stress, the GO films were transformed into graphene foam.

### EXAMPLE 7

### Graphene Foams from Hydrothermally Reduced Graphene Oxide

For comparison, a self-assembled graphene hydrogel (SGH) sample was prepared by a one-step hydrothermal method. In a typical procedure, the SGH can be easily prepared by heating 2 mg/mL of homogeneous graphene oxide (GO) aqueous dispersion sealed in a Teflon-lined autoclave at 180° C. for 12 h. The SGH containing about 2.6% (by weight) graphene sheets and 97.4% water has an electrical conductivity of approximately 5×10⁻³ S/cm. Upon drying and heat treating at 1,500° C., the resulting graphene foam exhibits an electrical conductivity of approximately 1.5×10⁻¹ S/cm, which is 2 times lower than those of the presently invented graphene foams produced by heat treating at the same temperature.

### EXAMPLE 8

### Plastic Bead Template-Assisted Formation of Reduced Graphene Oxide Foams

A hard template-directed ordered assembly for a macro-porous bubbled graphene film (MGF) was prepared. Mono-disperse poly methyl methacrylate (PMMA) latex spheres were used as the hard templates. The GO liquid crystal prepared in Example 5 was mixed with a PMMA spheres suspension. Subsequent vacuum filtration was then conducted to prepare the assembly of PMMA spheres and GO sheets, with GO sheets wrapped around the PMMA beads. A composite film was peeled off from the filter, air dried and calcinated at 800° C. to remove the PMMA template and thermally reduce GO into RGO simultaneously. The grey free-standing PMMA/GO film turned black after calcination, while the graphene film remained porous. The resulting foam typically has a physical density in the range from approximately 0.05-0.6 g/cm³. The pore sizes can be varied between meso-scaled (2-50 nm) up to macro-scaled (several μm) depending upon the contents of non-carbon elements and the amount/type of blowing agent used. This level of flexibility and versatility in designing various types of graphene foams is unprecedented and un-matched by any prior art process.

### EXAMPLE 9

### Preparation of Graphene Foams from Graphene Fluoride

Several processes have been used by us to produce GF, but only one process is herein described as an example. In a typical procedure, highly exfoliated graphite (HEG) was prepared from intercalated compound C₂F·xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, ethanol, 1-propanol, 2-propanol, 1-butanol, tert-butanol, isoamyl alcohol) and subjected to an ultrasound treatment (280 W) for 30 min, leading to the formation of homogeneous yellowish dispersions. Five minutes of sonication was enough to obtain a relatively homogenous dispersion, but longer sonication times ensured better stability. Upon casting on a glass surface with the solvent removed, the dispersion became a brownish film formed on the glass surface. When GF films were heat-treated, fluorine was released as gases that helped to generate pores in the film. In some samples, a physical blowing agent (N₂ gas) was injected into the wet GF film while being cast. These samples exhibit much higher pore volumes or lower foam densities. Without using a blowing agent, the resulting graphene fluoride foams exhibit physical densities from 0.35 to 1.38 g/cm³. When a blowing agent was used (blowing agent/GF weight ratio from 0.5/1 to 0.05/1), a density from 0.02 to 0.35 g/cm³ was obtained. Typical fluorine contents are from 0.001% (HTT=2,500° C.) to 4.7% (HTT=350° C.), depending upon the final heat treatment temperature involved.

### EXAMPLE 10

### Preparation of Graphene Foams from Nitrogenated Graphene

Graphene oxide (GO), synthesized in Example 2, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene : urea mass ratios of 1:0.5, 1:1 and 1:2 are designated as NGO-1, NGO-2 and NGO-3 respectively and the nitrogen contents of these samples were 14.7, 18.2 and 17.5 wt % respectively as found by elemental analysis. These nitrogenated graphene sheets remain dispersible in water. The resulting suspensions were then cast, dried, and heat-treated initially at 200-350° C. as a first heat treatment temperature and subsequently treated at a second temperature of 1,500° C. The resulting nitrogenated graphene foams exhibit physical densities from 0.45 to 1.28 g/cm³. Typical nitrogen contents of the foams are from 0.01% (HTT=1,500° C.) to 5.3% (HTT=350° C.), depending upon the final heat treatment temperature involved.

We claim:

1. A face mask for use by a wearer having a face, mouth, and nose, the face mask comprising:
a) a mask body configured to cover at least wearer's mouth and nose; and
b) a fastener to hold the mask in place on the wearer's face, the fastener including a portion that engages with the mask body and a portion that engages with the wearer;
wherein the mask body comprises (i) an air-permeable outer layer, (ii) an inner layer located on an inner side of the mask body, and (iii) a layer of graphene foam that is disposed in the mask body , wherein said fastener connects the mask body to the wearer.

2. The face mask of claim 1, wherein said graphene foam layer is disposed between the outer layer and the inner layer.

3. The face mask of claim 1, wherein said graphene foam layer is embedded in the outer layer.

4. The face mask of claim 1, wherein said graphene foam layer is embedded in the inner layer.

5. The face mask of claim 1, wherein said layer of graphene foam comprises a graphene material selected from pristine graphene, graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

6. The face mask of claim 1, wherein said graphene foam layer is chemically bonded to a surface of the mask body using an adhesive or binder.

7. The face mask of claim 1, wherein the graphene foam layer has a density from 0.005 to 1.0 g/cm³ or a specific surface area from 40 to 2,600 m²/g.

8. The face mask of claim 1, wherein the graphene foam layer has a specific surface area from 200 to 2,000 m²/g or a density from 0.01 to 0.5 g/cm³.

9. The face mask of claim 1, wherein the graphene foam layer is a discrete layer.

10. The face mask of claim 1, wherein at least one of the outer layer or the inner layer comprises a woven or nonwoven structure of polymer fibers or glass fibers.

11. The face mask of claim 1, wherein the fastener comprises a pair of ear straps that extend from both sides of the mask body and are configured to be hooked around wearer's ears, or an elastic strap that is hooked around wearer's head.

12. The face mask of claim 1, wherein the outer layer or the inner layer comprises polymer fibers selected from the group of cotton, cellulose, wool, polyolefins, polyester, polyamide, rayon, polyacrylonitrile, cellulose acetate, polystyrene, polyvinyls, poly (carboxylic acid), a biodegradable polymer, a water-soluble polymer, copolymers thereof, and combinations thereof.

13. The face mask of claim 1, wherein said graphene foam layer has an oxygen content from 5% to 50% by weight based on the total graphene sheet weight.

14. The face mask of claim 1, wherein the mask body further comprises an anti-microbial compound.

15. The face mask of claim 1, wherein the mask body further comprises an anti-microbial compound distributed on pore wall surfaces of the graphene foam layer.

16. The face mask of claim 15, wherein the anti-microbial compound comprises an antiviral or anti-bacteria compound selected from acrylic acid, methacrylic acid, citric acid, an acidic polymer, a silver-organic idine antibacterial agent, an iodine resin, a sialic acid, a cationic group, a sulfonamide, a fluoroquinolone, or a combination thereof.

17. A filtration member for use in the face mask of claim 1, said filtration member comprising a layer of woven or nonwoven fabric having two primary surfaces and a layer of graphene foam deposited on at least one of the two primary surfaces or embedded in the layer of woven or nonwoven fabric.

18. The filtration member of claim 17, wherein said graphene foam layer is chemically bonded to said at least one of the primary surfaces using an adhesive or binder.

19. The filtration member of claim 17, wherein the graphene foam layer has a density from 0.005 to 1.0 g/cm³ or a specific surface area from 40 to 2,600 m²/g.

20. The filtration member of claim 17, wherein the graphene foam layer has a specific surface area from 200 to 2,000 m²/g or a density from 0.01 to 0.5 g/cm³.

21. A filtration device comprising the filtration member of claim 17 as a filtration member.

22. The filtration device of claim 21, which is a water-purifying device, an air-purifying device, a solvent-removing device, or an oil-recovering device.
